(19) United States
(12) Patent Application Publication
(10) Pub. No.: US 2007/0231675 A1
(43) Pub. Date: Oct. 4, 2007

(54) Membrane-electrode assembly for fuel cell and fuel cell system comprising same

(76) Inventor: In-Hyuk Son, Suwon-si (KR)

Correspondence Address: Robert E. Bushnell;Suite 300, 1522 K Street, N.W., Washington, DC, 20005, US

(21) Appl. No.: 11/640,212

(22) Filed: Dec. 18, 2006

(30) Foreign Application Priority Data
Dec. 19, 2005 (KR) 10-2005-0125415

(51) Int. Cl. H01M 4/86; H01M 8/10; H01M 4/92; H01M 4/96

(52) U.S. Cl. 429/44; 429/30

(57) ABSTRACT

A membrane-electrode assembly constructed as an embodiment of the present invention includes double catalyst layers on an anode or a cathode. The compositions and particle sizes of the double catalyst layers can be different from each other. The membrane-electrode assembly of the present invention includes a cathode and an anode facing each other, and a polymer electrolyte membrane interposed therebetween. At least one of the anode and the cathode includes an electrode substrate, a first catalyst layer formed on the electrode substrate and including a first catalyst, and a second catalyst layer formed on the first catalyst layer and including a second catalyst. Power density of a fuel cell with the membrane-electrode assembly, which has the double catalyst layers, is greatly improved. The fuel cell with this membrane-electrode assembly also shows high efficiency and high power output.

### CLAIM OF PRIORITY

This application makes reference to, incorporates the same herein, and claims all benefits accruing under 35 U.S.C.§119 from an application for MEMBRANE-ELECTRODE ASSEMBLY FOR FUEL CELL AND FUEL CELL SYSTEM COMPRISING SAME earlier filed in the Korean Intellectual Property Office on 19 Dec. 2005 and there duly assigned Serial No. 10-2005-0125415.

### BACKGROUND OF THE INVENTION

1. Field of the Invention

The present invention relates to a membrane-electrode assembly for a fuel cell and a fuel cell system including the same. More particularly, the present invention relates to a membrane-electrode assembly for a fuel cell having high efficiency and high power, and a fuel cell system including the same.

2. Description of the Related Art

A fuel cell is a power generation system that produces electrical energy through an electrochemical redox reaction of an oxidant and hydrogen which is contained in a hydrocarbon-based material such as methanol, ethanol, or natural gas. Such a fuel cell is a clean energy source that can replace energy sources depending on fossil fuels. The fuel cell includes a stack composed of a unit cell, and produces various ranges of power output. Since the fuel cell has four to ten times higher energy density than a small lithium battery, it has been recognized as a small portable power source.

Examples of types of fuel cells include a polymer electrolyte membrane fuel cell (PEMFC) and a direct oxidation fuel cell (DOFC). The direct oxidation type fuel cell includes a direct methanol fuel cell that uses methanol as a fuel.

The polymer electrolyte fuel cell has an advantage of a high energy density, but it also has disadvantages that hydrogen gas needs to be carefully handled and the polymer electrolyte fuel cell requires accessory facilities such as a fuel reforming processor for reforming methane or methanol, natural gas, and the like in order to produce hydrogen as the fuel gas.

On the contrary, a direct oxidation fuel cell has a lower energy density than that of the polymer electrolyte fuel cell, but it has the advantages of easy handling of a fuel, being able to be operated at room temperature due to its low operation temperature, and no need for additional fuel reforming processors.

In the above fuel cells, the stack that generates electricity substantially includes several to scores of unit cells stacked in multiple layers, and each unit cell is formed of a membrane-electrode assembly (MEA) and a separator (also referred to as a bipolar plate). The membrane-electrode assembly is composed of an anode (also referred to as a “fuel electrode” or an “oxidation electrode”) and a cathode (also referred to as an “air electrode” or a “reduction electrode”) that are separated by a polymer electrolyte membrane.

A fuel is supplied to the anode and adsorbed on catalysts of the anode, and the fuel is oxidized to produce protons and electrons. The electrons are transferred into the cathode via an external circuit that externally connects the anode and cathode, and the protons are internally transferred into the cathode through the polymer electrolyte membrane. In addition, an oxidant is supplied to the cathode, and then the oxidant, protons, and electrons react with a catalyst of the cathode to produce electricity along with water.

### SUMMARY OF THE INVENTION

One embodiment of the present invention provides a membrane-electrode assembly having high efficiency and high power. Another embodiment of the present invention provides a fuel cell system including the membrane-electrode assembly.

According to one embodiment of the present invention, a membrane-electrode assembly is provided that includes a cathode and an anode facing each other, and a polymer electrolyte membrane interposed therebetween. At least one of the anode and the cathode includes an electrode substrate, a first catalyst layer formed on the electrode substrate and including a first catalyst, and a second catalyst layer formed on the first catalyst layer and including a second catalyst.

The first catalyst includes a carrier and a first metal supported on the carrier, and the second catalyst includes a second metal. The first catalyst layer has a thickness ranging from 10 μm to 50 μm, and preferably has a thickness ranging from 20 μm to 40 μm. The second catalyst layer has a thickness ranging from 1 μm to 10 μm, and preferably has a thickness ranging from 2 μm to 8μm.

The first and second metals can be the same or different. Each of the first catalyst metal and the second catalyst metal selected from the group consisting of platinum, ruthenium, osmium, a platinum-ruthenium alloy, a platinum-osmium alloy, a platinum-palladium alloy, a platinum-M alloy, and combinations thereof, where M is a transition element selected from the group consisting of gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), and combinations thereof.

The membrane-electrode assembly can be applicable to a direct oxidation fuel cell.

According to another embodiment of the present invention, a fuel cell system is provided that includes at least one electricity generating element, a fuel supplier, and an oxidant supplier. The electricity generating element includes the membrane-electrode assembly described above, and separators arranged at each side thereof. The fuel cell system can be a direct oxidation fuel cell system.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view showing a structure of a polymer electrolyte membrane and an anode of the membrane-electrode assembly constructed as one embodiment of the present invention.

FIG. 2 schematically shows the structure of a fuel cell system constructed according to the principles of one embodiment of the present invention.

### DETAILED DESCRIPTION OF THE INVENTION

Exemplary embodiments of the present invention will hereinafter be described in detail with reference to the accompanying drawings.

The present invention relates to a membrane-electrode assembly for a fuel cell, particularly to an electrode catalyst in a membrane-electrode assembly. A catalyst structure has a large effect on performance of a membrane-electrode assembly, because mass transfer and electrochemical characteristics largely depends on the catalyst structure.

According to one embodiment of the present invention, a structure of a catalyst layer is optimized to improve performance of a membrane-electrode assembly. The membrane-electrode assembly of the present invention includes an anode. The anode has a double-layer structure including a first catalyst layer and a second catalyst layer disposed on the first catalyst layer.

The first catalyst layer is disposed on an electrode substrate and includes a first catalyst including a carrier and a first metal supported on the carrier. The first catalyst layer has a thickness ranging approximately from 10 μm to 50 μm. According to another embodiment, the first catalyst layer has a thickness ranging approximately from 20 μm to 40 μm. When the thickness of the first catalyst layer is less than 10 μm, an amount of a catalyst is not enough to obtain high power. When the thickness of the first catalyst layer is greater than 50 μm, discharge of carbon dioxide (CO₂) and supply of the fuel are limited, and resultantly power decreases because of mass transfer resistance.

The size of the particles of the first catalyst of the first catalyst layer is not limited to a specific size, and any size of the first catalyst particles can be employed in the present invention.

The first metal includes a material such as platinum, ruthenium, osmium, a platinum-ruthenium alloy, a platinum-osmium alloy, a platinum-palladium alloy, a platinum-M alloy, or combinations thereof. In the platinum-M alloy, M is a transition element such as gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), or combinations thereof. According to one embodiment, platinum or a platinum-ruthenium alloy is preferred in terms of catalyst activity and poisoning inhibition.

The carrier can include a carbon such as acetylene black, denka black, activated carbon, ketjen black, or graphite, or an inorganic particulate such as alumina, silica, zirconia, or titania. Carbon is generally used.

The second catalyst layer is disposed on the first catalyst layer, and includes a second catalyst including a second metal. The second catalyst layer has a thickness ranging approximately from 1 μm to 10 μm. According to another embodiment, the second catalyst layer has a thickness ranging approximately from 2 μm to 8 μm. When the thickness of the second catalyst layer is less than 1 μm, high power cannot be obtained at high current density. When it is greater than 10 μm, discharge of carbon dioxide (CO₂) and supply of the fuel are limited, and resultantly power decreases because of mass transfer resistance.

The size of the particles of the second catalyst of the second catalyst layer is not limited to a specific size, and any size of the first catalyst particles can be employed in the present invention. The second metal of the second catalyst is not supported on a carrier, while the first metal of the first catalyst is supported on a carrier. Therefore, the particle size of the second catalyst is normally smaller than the particle size of the first catalyst. Herein, a metal that is not supported on a carrier is referred to as an unsupported metal.

The second metal includes platinum, ruthenium, osmium, a platinum-ruthenium alloy, a platinum-osmium alloy, a platinum-palladium alloy, a platinum-M alloy, or combinations thereof. in the platinum-M alloy, M is a transition element such as gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), or combinations thereof. According to one embodiment, platinum or a platinum-ruthenium alloy is preferred in terms of catalyst activity and poisoning inhibition.

The first and second metals can be the same or different.

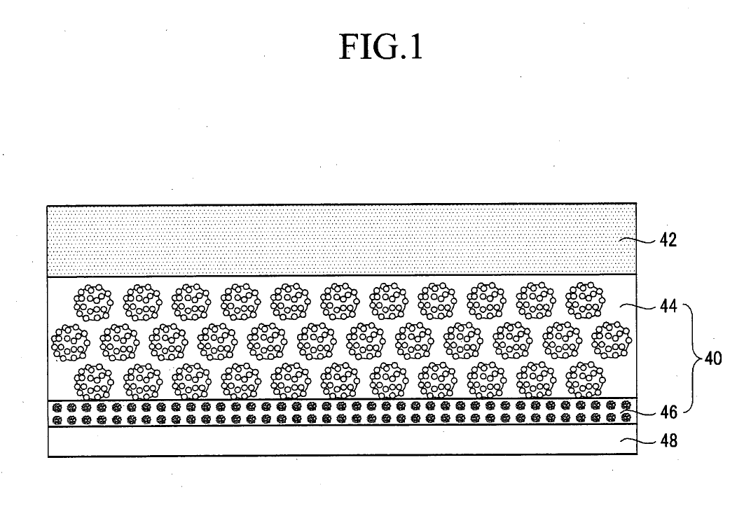

As shown in FIG. 1, catalyst layer 40 is disposed contacting polymer electrolyte membrane 48. The average size of the particles of the second catalyst of second catalyst layer 46 contacting polymer electrolyte membrane 48 is smaller than the average size of the particles of the first catalyst in first catalyst layer 44 contacting electrode substrate 42. Therefore, second catalyst layer 46 is relatively denser than first catalyst layer 44. Dense second catalyst layer 46 acts as a barrier to prevent fuel transfer, and thereby crossover of fuel through polymer electrolyte membrane 48 can be prevented.

Since first catalyst layer 44 includes the first catalyst having a large size particle, first catalyst layer 44 includes large pores between the catalyst particles, and thereby fuel can be smoothly supplied through first catalyst layer 44, and by-products such as CO₂ generated in the cell reactions can be easily discharged through first catalyst layer 44. As a result, fuel crossover is prevented, and catalyst activity for fuel oxidation and oxidant reduction reactions increases, and thereby fuel cells with high power output and high efficiency can be provided.

The effect of the electrode structure having a first and second catalyst layers, which is described above, can be effectively maximized when this electrode structure is applied to a direct oxidation fuel cell.

The electrode substrate of the anode of one embodiment of the present invention supports an electrode and spreads a fuel to a catalyst layer to make the fuel to easily approach the catalyst layer. As for the electrode substrate, a conductive substrate is used. An example of the conductive material formed on the conductive substrate is a carbon paper, a carbon cloth, a carbon felt, or a metal cloth (a porous film including metal cloth fiber or a metalized polymer fiber), but it is not limited thereto. The electrode substrate may be treated with a fluorine-based resin to make the electrode substrate water-repellent, which can prevent deterioration of reactant diffusion efficiency due to water generated during fuel cell operation. The fluorine-based resin includes polyvinylidene fluoride, polytetrafluoroethylene, fluorinated ethylene propylene, polychlorotrifluoroethylene, fluoroethylene polymers, or so on.

A microporous layer (MPL) can be added between the aforementioned electrode substrate and the catalyst layer to increase reactant diffusion effects. The microporous layer generally includes conductive powders with a certain particle diameter. The conductive powder may include, but is not limited to, carbon powder, carbon black, acetylene black, activated carbon, carbon fiber, fullerene, nano-carbon, or combinations thereof. The nano-carbon may include a material such as carbon nanotubes, carbon nanofiber, carbon nanowire, carbon nanohoms, carbon nanorings, or combinations thereof. The microporous layer is formed by coating a composition including a conductive powder, a binder resin, and a solvent on the conductive substrate. The binder resin may include, but is not limited to, polytetrafluoro ethylene, polyvinylidene fluoride, polyvinyl alcohol, cellulose acetate, polyhexafluoro propylene, polyperfluoroalkylvinyl ether, polyperfluoro sulfonylfluoride alkoxy vinyl ether, or copolymers thereof. The solvent may include, but is not limited to, an alcohol such as ethanol, isopropylalcohol, n-propylalcohol, butanol, or so on, water, dimethyl acetamide, dimethyl sulfoxide, or N-methylpyrrolidone. The coating method may include, but is not limited to, screen printing, spray coating, doctor blade methods, gravure coating, dip coating, silk screening, painting, or so on, depending on the viscosity of the composition.

A cathode, together with the anode, forms a membrane-electrode assembly. The cathode is made of a material such as platinum, ruthenium, osmium, platinum-ruthenium alloys, platinum-osmium alloys, platinum-palladium alloys, platinum-M alloys, and combinations thereof, wherein M is selected from the group consisting of gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), or combinations thereof. A metal supported on a carrier can be used for the cathode, and the carrier can be the same as in the anode.

The polymer electrolyte membrane interposed between the anode and the cathode can be any polymer resin having a cation exchange group at its side chain such as a sulfonic acid group, a carboxylic acid group, a phosphoric acid group, a phosphonic acid group, or derivatives thereof. Examples of the polymer resin include at least one proton conductive polymer such as fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, or polyphenylquinoxaline-based polymers. In one embodiment, the proton conductive polymer is selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly (2,5-benzimidazole).

In the above descriptions referring to FIG. 1, it is described that the first catalyst layer and the second catalyst layer are formed in an anode, but the first catalyst layer and the second catalyst layer can be formed in a cathode instead of the anode. Therefore, it can be also described that the first layer and the second layer is formed in a first electrode structure. The first electrode structure can be an anode or a cathode. Then, the membrane-electrode assembly includes a first electrode structure, a second electrode structure, and a polymer electrolyte membrane interposed between the first electrode structure and the second electrode structure.

A fuel cell system of the present invention that includes the above membrane-electrode assembly includes at least one electricity generating element, a fuel supplier and an oxidant supplier. The electricity generating element includes a membrane-electrode assembly, and separators positioned at both sides of the membrane-electrode assembly. It generates electricity through oxidation of a fuel and reduction of an oxidant.

The fuel supplier supplies a fuel to the electricity generating element. The fuel includes liquid or gaseous hydrogen, or a hydrocarbon-based fuel such as methanol, ethanol, propanol, butanol, or natural gas.

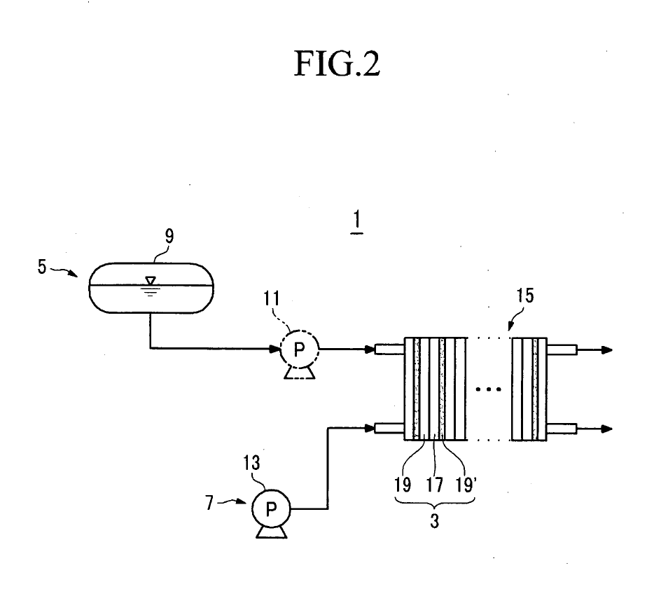

FIG. 2 shows a schematic structure of a fuel cell system that will be described in detail with reference to this accompanying drawing. FIG. 2 illustrates fuel cell system 1 where a fuel and an oxidant are provided to electricity generating element 3 through pumps 11 and 13, but the present invention is not limited to this structure. The fuel cell system of the present invention can alternatively include a structure where a fuel and an oxidant are provided in a manner of diffusion.

Fuel cell system 1 includes at least one electricity generating element 3 that generates electrical energy through an electrochemical reaction of a fuel and an oxidant, fuel supplier 5 for supplying a fuel to electricity generating element 3, and oxidant supplier 7 for supplying an oxidant to electricity generating element 3. Fuel supplier 5 is equipped with tank 9 that stores the fuel, and pump 11 that is connected to tank 9. Fuel pump 11 supplies fuel stored in tank 9 to electricity generating element 3 with a predetermined pumping power.

Oxidant supplier 7, which supplies an oxidant to electricity generating element 3, is equipped with at least one pump 13 for supplying an oxidant to electricity generating element 3 with a predetermined pumping power.

Electricity generating element 3 includes membrane-electrode assembly 17, which oxidizes hydrogen or a fuel and reduces an oxidant, and separators 19 and 19′, one of which is positioned on one side of membrane-electrode assembly 17 and the other of which is positioned on the opposite side of membrane-electrode assembly 17. Separators 19 and 19′ supply hydrogen or a fuel, and the oxidant to membrane-electrode assembly 17. Stack 15 includes at least one electricity generating element 17.

The following examples illustrate the present invention in more detail. However, it is understood that the present invention is not limited by these examples.

### EXAMPLE 1

88 wt % of Pt—Ru black (Johnson Matthey) catalyst and 12 wt % of binder, which was a 5 wt % NAFIO/H₂O/2-propanol (Solution Technology Inc.), were mixed to prepare a catalyst layer composition for an anode. A carbon paper electrode substrate (SGL Carbon Co. GDL 25BC) was coated with the catalyst layer composition for an anode to prepare an anode. Herein, the catalyst was loaded in an amount of 5 mg/cm² on the substrate.

A first catalyst was made by mixing 88 wt % of Pt supported on carbon and 12 wt % of binder (5 wt % NAFION/H₂O/2-propanol (Solution Technology Inc.)) to prepare a first catalyst composition for a cathode. A second catalyst was made by mixing 88 wt % of Pt blacks (Johnson Matthey) and 12 wt % of binder (5 wt % NAFION/H₂O/2-propanol (Solution Technology Inc.)) to prepare a second catalyst composition for a cathode.

The carbon paper electrode substrate (GDL 10DA of SGL Carbon Group) was coated with the first catalyst composition for a cathode to form a first catalyst layer with 40 μm thickness, and the first catalyst layer was coated with the second catalyst composition to form a second catalyst layer with 10 μm thickness. Thereby a cathode with the first catalyst layer and the second catalyst layer was fabricated. An amount of the catalyst loaded on first catalyst layer of the cathode was 2 mg/cm², and an amount of the catalyst loaded on the second catalyst layer was 2 mg/cm².

The anode, cathode, and a 115 (perfluorosulfonate) polymer electrolyte membrane of commercial NAFION were assembled to make a membrane electrode assembly of a unit cell.

### COMPARATIVE EXAMPLE 1

88 wt % of Pt—Ru black (Johnson Matthey) catalyst and 12 wt % of binder (a 5 wt % NAFION/H₂O/2-propanol (Solution Technology Inc.)) were mixed to prepare a catalyst layer composition for an anode. The catalyst layer composition for an anode was coated on a carbon paper electrode substrate (GDL 25BC of SGL Carbon Co.) to prepare an anode. Herein, the catalyst was loaded in an amount of 5 mg/cm² on the anode.

88% of Pt black (Johnson Matthey) catalyst and 12 wt % of binder (5 wt % NAFION/H₂O/2-propanol (Solution Technology Inc.)) were mixed to prepare a catalyst composition for a cathode. The carbon paper electrode substrate (SGL Carbon Co. GDL 10DA) was coated with the catalyst composition for a cathode to form a cathode. Here, an amount of the catalyst loaded on the entire catalyst of the cathode was 5 mg/cm².

The anode, cathode, and a 115 (perfluorosulfonate) polymer electrolyte membrane of commercial NAFION were assembled to make a membrane electrode assembly of a unit cell.

1M methanol was supplied to the unit cells to operate the unit cells. Power densities of the fuel cells at 0.45 V, 0.4 V, and 0.35 V were measured at 50° C., 60° C., and 70° C. The result are provided in Table 1.

TABLE 1

| | 50° C. | | | 60° C. | | | 70° C. | | |
|---|---|---|---|---|---|---|---|---|---|
| | 0.45 V | 0.4 V | 0.35 V | 0.45 V | 0.4 V | 0.35 V | 0.45 V | 0.4 V | 0.35 V |
| Comp | 40 mW/cm² | 65 mW/cm² | 80 mW/cm² | 63 mW/cm² | 90 mW/cm² | 118 mW/cm² | 90 mW/cm² | 110 mW/cm² | 139 mW/cm² |
| Ex 1 | | | | | | | | | |
| Ex 1 | 45 mW/cm² | 70 mW/cm² | 87 mW/cm² | 70 mW/cm² | 98 mW/cm² | 135 mW/cm² | 98 mW/cm² | 135 mW/cm² | 156 mW/cm² |

As shown in Table 1, the fuel cell of Example 1, which includes a supported first catalyst layer and a non-supported black type second catalyst layer, has improved power density compared to the fuel cell of Comparative Example 1, which includes only a non-supported black catalyst. Particularly, as the temperature increases, the power density of Example 1 further improves.

As described above, the membrane-electrode assembly constructed as an embodiment of the present invention includes a double-layered anode catalyst layer including different catalyst compositions and particle sizes, and fuel cell made with the membrane-electrode assembly shows high efficiency and high power output.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A membrane-electrode assembly for a fuel cell comprising:
a first electrode structure comprising:
an electrode substrate;
a first catalyst layer formed on the electrode substrate, the first catalyst layer including a first catalyst that includes a carrier and a first metal supported on the carrier; and
a second catalyst layer formed on the first catalyst layer, the second catalyst layer including a second catalyst that includes an unsupported second metal;
a second electrode structure facing the second catalyst layer of the first electrode structure; and
a polymer electrolyte membrane interposed between the first electrode structure and the second electrode structure.

2. The membrane-electrode assembly of claim 1, comprised of the first catalyst layer having a thickness ranging from about 10 micro-meters to about 50 micro-meters.

3. The membrane-electrode assembly of claim 2, comprised of the first catalyst layer having a thickness ranging from about 20 micro-meters to about 40 micro-meters.

4. The membrane-electrode assembly of claim 1, comprised of the second catalyst having a thickness ranging from about 1 micro-meter to 10 micro-meters.

5. The membrane-electrode assembly of claim 4, comprised of the second catalyst having a thickness ranging from about 2 micro-meters to 8 micro-meters.

6. The membrane-electrode assembly of claim 1, wherein each of the first metal and the second metal is selected from the group consisting of platinum, ruthenium, osmium, a platinum-ruthenium alloy, a platinum-osmium alloy, a platinum-palladium alloy, a platinum-M alloy, and combinations thereof, where M is a transition element selected from the group consisting of gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), and combinations thereof.

7. The membrane-electrode assembly of claim 6, wherein each of the first metal and the second metal includes platinum or a platinum-ruthenium alloy.

8. The membrane-electrode assembly of claim 1, wherein the carrier includes a carbon or an inorganic material.

9. The membrane-electrode assembly of claim 1, wherein an average particle size of the first catalyst is larger than an average particle size of the second catalyst.

10. A fuel cell system comprising:
an electricity generating element that generates electricity through oxidation of a fuel and reduction of an oxidant, comprising:
at least two separators; and
a membrane-electrode assembly disposed between the separators, the membrane-electrode assembly comprising:
a first electrode structure comprising:
an electrode substrate;
a first catalyst layer formed on the electrode substrate, the first catalyst layer including a first catalyst that includes a carrier and a first metal supported on the carrier; and
a second catalyst layer formed on the first catalyst layer, the second catalyst layer including a second catalyst that includes an unsupported second metal;
a second electrode structure facing the second catalyst layer of the first electrode structure; and
a polymer electrolyte membrane interposed between the first electrode structure and the second electrode structure.
a fuel supplier for supplying the fuel to the electricity generating element; and
an oxidant supplier for supplying the oxidant to the electricity generating element.

11. The fuel cell system of claim 10, comprised of the first catalyst layer having a thickness ranging from about 10 micro-meters to about 50 micro-meters.

12. The fuel cell system of claim 11, comprised of the first catalyst layer having a thickness ranging from about 20 micro-meters to about 40 micro-meters.

13. The fuel cell system of claim 10, comprised of the second catalyst having a thickness ranging from about 1 micro-meter to 10 micro-meters.

14. The fuel cell system of claim 13, comprised of the second catalyst having a thickness ranging from about 2 micro-meters to 8 micro-meters.

15. The fuel cell system of claim 10, wherein each of the first metal and the second metal is selected from the group consisting of platinum, ruthenium, osmium, a platinum-ruthenium alloy, a platinum-osmium alloy, a platinum-palladium alloy, a platinum-M alloy, and combinations thereof, where M is a transition element selected from the group consisting of gallium (Ga), titanium (Ti), vanadium (V), chromium (Cr), manganese (Mn), iron (Fe), cobalt (Co), nickel (Ni), copper (Cu), zinc (Zn), tin (Sn), molybdenum (Mo), tungsten (W), rhodium (Rh), and combinations thereof.

16. The fuel cell system of claim 15, wherein each of the first metal and the second metal includes platinum or a platinum-ruthenium alloy.

17. The fuel cell system of claim 10, wherein the carrier includes a carbon or an inorganic material.

18. The fuel cell system of claim 10, wherein the fuel cell system includes a direct oxidation fuel cell system.
